(19) United States
(12) Patent Application Publication
(10) Pub. No.: US 2018/0100245 A1
(43) Pub. Date: Apr. 12, 2018

(54) A LIGHT METAL OR ALLOY MATRIX WORKPIECE HAVING TAILOR COATED CORROSION RESISTANT LAYERS AND METHODS FOR MAKING THE SAME

(71) Applicants: GM GLOBAL TECHNOLOGY OPERATIONS LLC, Detroit, MI (US); NANJING HAORANG ENVIRONMENT SCIENCE & TECHNOLOGY CO., LTD, Jiangsu (CN)

(72) Inventors: Ming LIU, Shanghai (CN); Yanfeng GE, Luoyang (CN)

(73) Assignees: GM GLOBAL TECHNOLOGY OPERATIONS LLC, Detroit, MI (US); NANJING HAORANG ENVIRONMENT SCIENCE & TECHNOLOGY CO. LTD, Jiangsu (CN)

(21) Appl. No.: 15/565,026

(22) PCT Filed: Apr. 7, 2015
(86) PCT No.: PCT/CN2015/075998

§ 371 Date: Oct. 6, 2017

(51) Int. Cl. C25D 11/02; C25D 11/30; C25D 13/04; C09D 5/08; C09D 5/44

(52) U.S. Cl. CPC C25D 11/022; C25D 11/30; C25D 13/04; B60B 2310/621; C09D 5/4465; B60B 2900/141; C09D 5/08

(57) ABSTRACT

Customizable methods of protecting select regions of a light metal or alloy workpiece, such as a wheel (10), from corrosion are provided. The light metal or alloy may be magnesium, aluminum, or titanium. A first region (50) of the exposed surface (40) is identified that has increased exposure to corrosive agents in an external environment (in service conditions) as compared to a second region (52). Thus, a corrosion resistant coating is selectively formed over the first region (50) of the exposed surface (40). The second region (52) may have a second distinct corrosion resistant coating. Methods for selectively and efficiently forming such corrosion resistant systems are provided. In certain methods, the locations where the corrosion resistant coating is applied are controlled by immersing only select portions of or selectively masking the workpiece in a micro-arc oxidation electrolyte bath. In other methods, the thicknesses of the coatings are locally tailored by controlling the electric field.

### FIELD

The present disclosure relates to coatings and methods of applying customized surface treatments for increased corrosion resistance of metals and alloys susceptible to corrosion and the customized tailor coated workpieces made therefrom.

### BACKGROUND

This section provides background information related to the present disclosure which is not necessarily prior art.

Alloy road wheels with high magnesium or aluminum content can be used on specialty and racing vehicles. The use of such alloy road wheels in less expensive passenger vehicles has, however, been limited to a few production sports cars. By way of example, galvanic corrosion is a design consideration in high magnesium content alloy wheels when mated to other metals, such as steel or cast iron wheel hubs, brake components, and other metal components in the wheel assembly. Frequently, these components may spend much of their service life in damp or wet conditions and are often exposed to road salts and other corrosive agents, which accelerate the galvanic corrosion reactions. Various coatings have been applied to light metal or alloy matrix workpieces and substrates, such as alloy wheels, for increasing corrosion protection, but they have had many drawbacks. For example, workpieces having only thick oxide layers formed thereon have been used, but were often brittle and prone to cracking, thus ultimately failing to provide adequate long term corrosion protection.

Workpieces having powder coating materials directly applied to oxide layers have shown poor adhesion. Workpieces having a combination of chemical passivation techniques with an oxide layer have been used, but have exhibited poor chipping resistance. Still further, workpieces simply having an electrocoating layer provided on an oxide layer have also been used, but may yield a product with poor scratch corrosion and poor thermal shock resistance.

In yet other alternatives, wheels may be provided as two-component assemblies having inner and outer portions, with the inner portion galvanically isolates from the outer portion from the steel or cast iron wheel hub and brake components. However, such two component assemblies can be expensive and may not always be desirable.

Accordingly, there remains a need for improved surface treatments for increased corrosion resistance of light metals and alloy matrices susceptible to corrosion. Further, there is a need for more economical improved and targeted surface treatments for corrosion resistance that can help reduce production costs of such light metals and alloy parts.

### SUMMARY

This section provides a general summary of the disclosure and is not a comprehensive disclosure of its full scope or all of its features.

The present disclosure provides enhanced, customizable corrosion protection systems for light metal or alloy matrix workpieces, such as those comprising a valve metal selected from the group consisting of magnesium, aluminum, titanium, and mixtures thereof. In certain aspects, the present disclosure provides a light metal or alloy workpiece having tailored or customized corrosion resistance surface protection. The light metal workpiece comprises a metal or alloy matrix having an exposed surface defining a first region and a second distinct region. The first region has increased exposure to one or more corrosive agents in an external environment as compared to the second region. A corrosion resistant coating is selectively formed over the first region of the exposed surface. The corrosion resistant coating comprises a corrosion resistant oxide layer formed by micro-arc oxidation and at least one sealant coating. The at least one sealant coating is applied onto at least a portion of the corrosion resistant oxide layer using an electro-coating technique and configured to seal the corrosion resistant oxide layer.

In other aspects, the present disclosure provides a method of creating a customized corrosion resistance coating system on an exposed surface of a light metal or alloy matrix substrate. The method optionally comprises generating a corrosion resistant oxide layer on a first region of the exposed surface of the light metal or alloy substrate using a micro-arc oxidation process. The exposed surface further defines a second region having reduced potential for exposure to one or more corrosive agents in an external environment as compared to the first region. The light metal or alloy comprises at least one valve metal selected from the group consisting of aluminum, magnesium, titanium, and mixtures thereof. The method further includes applying at least one sealant coating onto at least a portion of the corrosion resistant oxide layer using an electro-coating technique. The sealant coating is configured to seal the corrosion resistant oxide layer on the first region.

In yet other aspects, the present disclosure provides a method of creating a customized corrosion resistance coating system on an exposed surface of a magnesium or magnesium alloy matrix automotive component. The method comprises generating a corrosion resistant magnesium oxide layer on a first region of the exposed surface using a micro-arc oxidation process. The exposed surface further defines a second region having reduced potential for exposure to one or more corrosive agents in an external environment as compared to the first region. The method also includes applying a first coating layer onto the corrosion resistant magnesium oxide layer using an electro-coating technique. Then, a second coating layer is applied onto the first coating layer, where the second coating layer comprises a powder material coating comprising polyurethane.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front plan view of an exemplary wheel assembly according to various aspects of the present disclosure having a wheel and a tire;

FIG. 2 is a cross-sectional view of the wheel assembly taken along the line 2-2 of FIG. 1; and

FIG. 3 is a cross-sectional view of a wheel assembly according to various aspects of the present disclosure having a wheel and a tire illustrating various distinct corrosion susceptible surface regions on the wheel.

FIG. 4 is a simplified diagram representation illustrating corrosion resistant coatings that can be applied to a first surface region of an exposed surface of a light weight metal or alloy matrix workpiece according to certain aspects of the present disclosure.

FIG. 5 is a cross-sectional view of a light weight metal or alloy matrix wheel having an exposed surface with a first region and a second distinct region, each having different levels of corrosion susceptibility and thus requiring distinct corrosion protection coatings according to certain aspects of the present disclosure.

FIG. 6 is a cross-sectional view of a micro-arc oxidation processing system for selectively forming a corrosion resistant oxide layer on a first region of a light weight metal or alloy matrix wheel according to certain aspects of the present disclosure.

FIG. 7 is a cross-sectional view of another micro-arc oxidation processing system for selectively forming a corrosion resistant oxide layer on a first region of a light weight metal or alloy matrix wheel by use of masks protecting one or more second uncoated region(s) according to certain aspects of the present disclosure.

FIG. 8 is a cross-sectional view of yet another micro-arc oxidation processing system for selectively forming a corrosion resistant oxide layer on a first region of a light weight metal or alloy matrix wheel by use of a customized cathode according to certain aspects of the present disclosure.

Corresponding reference numerals indicate corresponding parts throughout the several views of the drawings.

### DETAILED DESCRIPTION

Example embodiments will now be described more fully with reference to the accompanying drawings.

The following description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Spatially relative terms, such as “inner,” “outer,” “beneath,” “below,” “lower,” “above,” “upper,” “on,” and the like, may be used herein for ease of description to describe one element or feature's relationship to another element(s) or feature(s). Spatially relative terms may encompass different orientations of the device in use or operation. As used herein, when one coating, layer, or material is “applied onto,” “applied over,” “formed on,” “deposited on,” etc. a substrate or item, the coating, layer, or material may be applied, formed, deposited on an entirety of the substrate or item, or on at least a portion of the substrate or item.

The present technology generally relates to enhanced surface coatings for light metal workpieces and valve metals. As used herein, the term “valve metal” is used to refer to a metal or metal alloy that can self-grow nano-porous oxide films. The resultant oxide layer formed on a valve metal may well provide some degree of corrosion protection, as it constitutes a physical barrier between the metal and a corrosive environment. However, it may not be aesthetically pleasing, and may not provide sufficient corrosion resistance for light metal workpieces, such as wheels, under certain conditions.

Example valve metals useful with the present technology include aluminum, magnesium, titanium, zirconium, hafnium, chromium, cobalt, molybdenum, vanadium, tantalum, and mixtures and alloys thereof. Valve metals may exhibit electrical rectifying behavior in an electrolytic cell and, under a given applied current, will sustain a higher potential when anodically charged than when cathodically charged.

Magnesium and its alloys are increasingly used in aerospace and automotive applications because of their ultra-lightness and high strength to weight ratio having a density that is two-thirds of aluminum and one-fourth of iron. Unfortunately, magnesium has high chemical affinity and reacts with atmospheric oxygen and water, resulting in the formation of porous oxide carbonate film on the surface, which does not offer corrosion protection. The metal corrodes in a variety of conditions, including moist air and in distilled water. Such corrosion is exacerbated in the presence of various salts and other known corrosive agents. The situation is even more complex for magnesium alloys. However, in various aspects, the present teachings provide a light metal workpiece, such as a valve metal or metal alloy, with enhanced and localized surface protection.

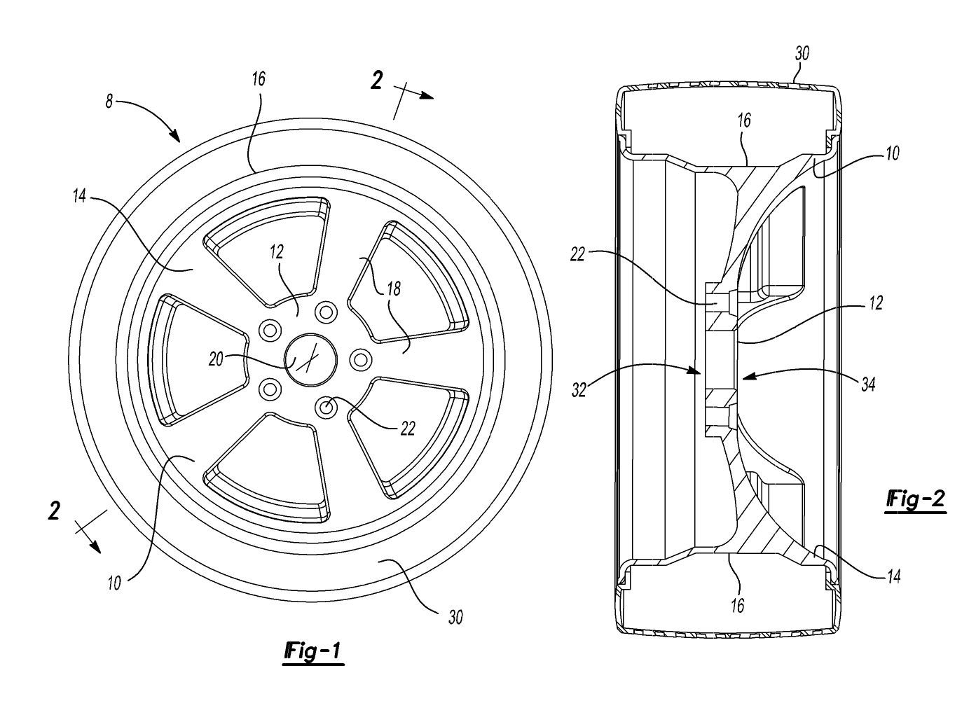

With reference to FIG. 1, in one aspect of the present disclosure, a wheel assembly 8 is shown. The wheel assembly 8 includes a light metal workpiece that may be a wheel 10, such as aluminum, magnesium, or alloy wheels. It should be understood that the technology of the present disclosure can generally be used with any wheel design, or any other workpiece or component envisioned to be made from a valve metal that may have an exposed surface subject to a potentially corrosive environment. For exemplary purposes, the wheel 10 may generally be a unitary member or optionally be provided with a center wheel portion 12 coupled with an outer wheel portion 14, as shown. The outer wheel portion 14 may include a rim 16 and may also include one or more spokes 18 extending from the rim 16 in a generally radial direction toward the center wheel portion 12. The center wheel portion 12 may include a center opening 20 suitable for a wheel cap (not shown) and may define one or more lug holes 22 useful for attaching the wheel 10 to a vehicle. The wheel assembly 8 also includes a tire 30 disposed around along the rim 16 of the outer wheel portion 14 of wheel 10.

Referring to FIG. 2, which is cross sectional view of FIG. 1 taken along the line 2-2, the wheel assembly 8, including wheel 10, may have an inboard side 32 and an outboard side 34. The inboard side 32 generally indicates the side of the wheel assembly 8 that faces the vehicle, and the outboard side 34 generally indicates the side of the wheel assembly 8 that faces away from the vehicle and visible when the wheel assembly 8 is attached to the vehicle.

In various aspects, the wheel 10 or other light metal workpiece comprises a metal or alloy matrix having an exposed surface 40 defining one or more distinct surface regions. The distinct surface regions have different potential for exposure to corrosive agents present in an external environment during service conditions. Thus, in accordance with various aspects of the present disclosure, at least two distinct surface regions of the exposed surface 40 of a light metal workpiece comprising a metal or alloy matrix are treated to selectively have different levels of corrosion protection coatings tailored to the relative susceptibility to corrosive agents in the external environment.

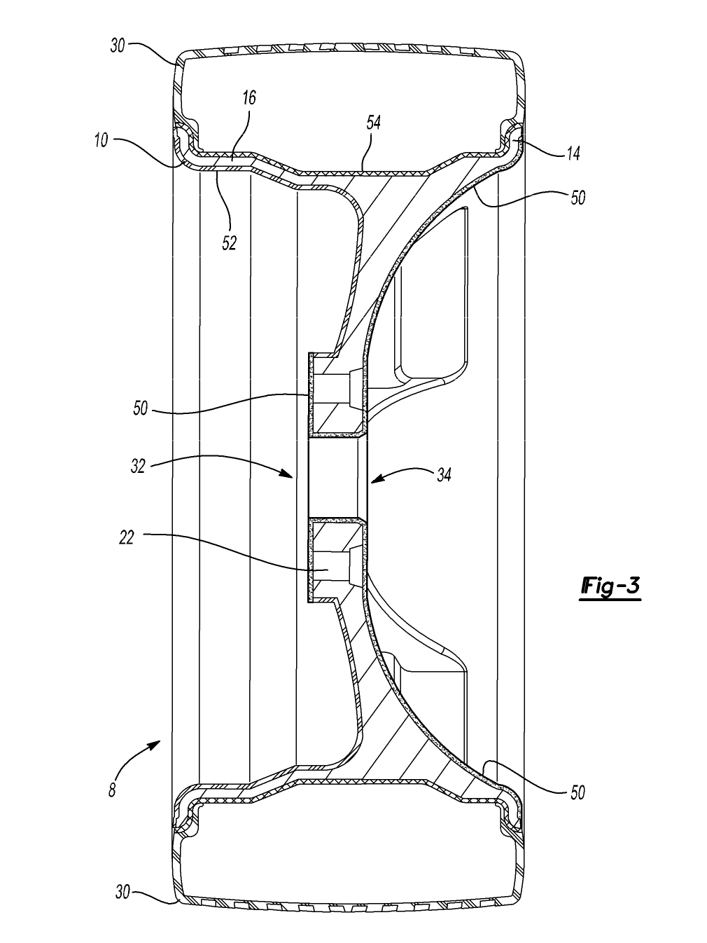

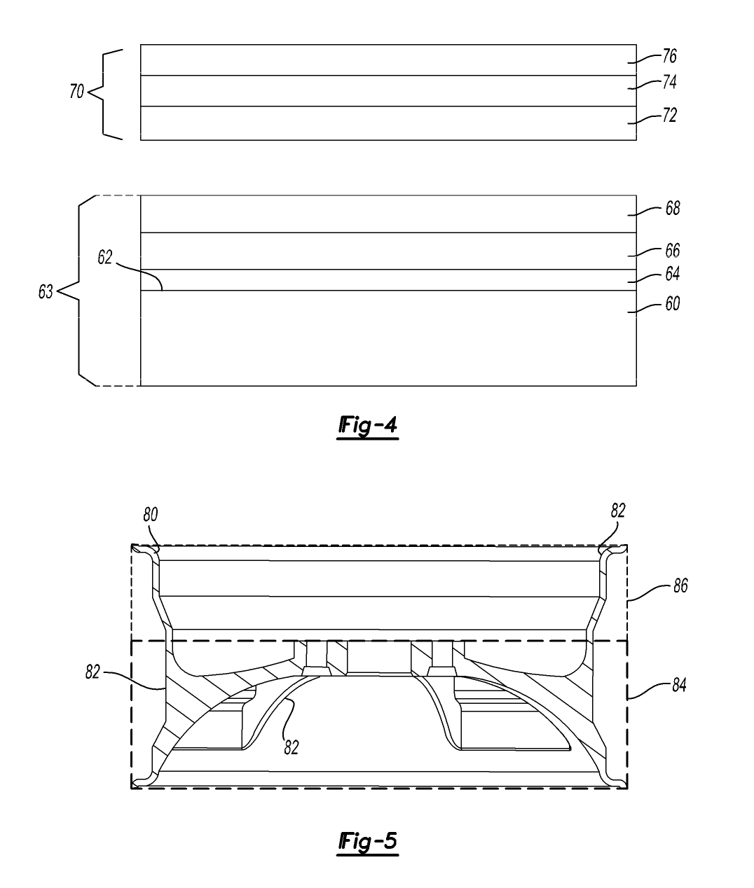

By way of example, FIG. 3 is another view of the wheel assembly 8 in FIGS. 1 and 2. The surface regions on exposed surface 40 of the light metal wheel 10 have distinct corrosion susceptibility and thus are designated independently in FIG. 4. First surface regions 50 on the exposed surface 40 or substrate of the wheel 10 have the greatest susceptibility to corrosion by wild exposure, because they are exposed on the outboard side 34 to an external corrosive environment. Such exposure includes exposure to the corrosive agents potentially present in the external environment. First surface regions 50 may also have galvanic contact with distinct metals in other components in the wheel assembly 8. For example, the lug holes 22 may have lug nuts (not shown) formed of distinct metals, such as steel, that are in direct contact with the wheel 10. The combination of the highest exposure to corrosive agents and galvanic contact with other metals makes the first surface regions 50 the most corrosion prone regions on the workpiece substrate of the wheel 10. Thus, the first surface regions 50 have the greatest or highest requirement for corrosion protection.

Second surface regions 52 are also susceptible to corrosion, but are disposed on the inboard side 32 and thus along a more protected back side of the wheel 10. Also, there is less galvanic contact exposure along second surface regions 52. Thus, the second surface regions 52 have less susceptibility to corrosion than first surface regions 50 and may be considered to require a medium or middle level of corrosion protection.

Lastly, wheel 10 defines third surface region(s) 54 defined along the rim 16 of the outer wheel portion 14 where the tire 30 is seated. The third surface region(s) 54 are the least corrosion prone regions on the wheel 10, having reduced exposure to the external environment and thus being protected from corrosive agents, as well as experiencing little or no galvanic contact. Thus, the third surface regions 54 of the wheel 10 have the least amount of susceptibility to corrosion as compared to the first surface regions 50 and the second surface regions 52. The third surface regions 54 can be considered to require only a low level of corrosion protection.

FIG. 4 is a simplified diagram representation illustrating various coatings that can be applied to select regions of an exposed surface 40 of a metal matrix according to various aspects of the present disclosure. As will be described in more detail below, such corrosion resistant coatings are particularly suitable for surface regions of the exposed surface 40 that have high levels of corrosion susceptibility (e.g., first surface regions 50 and optionally second surface regions 52 in FIG. 3). In FIG. 4, the metal matrix 60 of a light metal workpiece initially has an exposed surface 62. The light metal workpiece having the metal matrix exposed surface 62 may undergo various pretreatment processes as is known in the art, including degreasing, descaling, neutralization, and similar washing processes. A corrosion resistant coating 63 includes an oxide layer 64 formed on the exposed surface 62 using a micro-arc oxidation technique.

As is known in the art, micro-arc oxidation techniques (“MAO”), sometimes also referred to as plasma electrolytic oxidation, micro-plasma oxidation (MPO), spark anodizing, discharge anodizing, plasma electrolytic oxidation (PEO) by KERONITE™, BONDERITE™ MGC by Henkel; anodic spark deposition (ASD), anodic oxidation by spark deposition (ANOF), and other variations and combinations of these terms, may involve the use of various electrolytes to work in an electrolytic cell and that help generate a porous oxide layer, or porous oxide ceramic layer, at the exposed surface of metal matrix. By way of example, where the workpiece includes aluminum, the oxide layer or oxide ceramic layer may be formed using MAO techniques to yield a layer of alumina or an alumina ceramic, the composition of which may vary based on the electrolyte and other materials present therein. Where the workpiece includes magnesium, the oxide layer or ceramic oxide layer may be formed using MAO techniques to yield a layer of magnesia or magnesium oxide ceramic. Various conventional and commercial variants of the MAO processes, including those described in U.S. Pat. Nos. 3,293,158; 5,792,335; 6,365,028; 6,896,785; and U.S. patent application Ser. No. 13/262,779, published as U.S. Pub. Pat. App. No. 2012/0031765, each of which is incorporated herein by reference in its entirety. In one example, the MAO process may be performed using a silicate-based electrolyte that may include sodium silicate, potassium hydroxide, and potassium fluoride.

As is generally known in the art, the presence of micropores and/or cracks on the surface of MAO coatings can be considered to be both advantageous and detrimental for corrosion resistance. For example, the presence of a porous outer layer in MAO coatings can significantly improve the mechanical interlocking effect, the bonding area, and stress distribution, advantageously resulting in higher bond strength for the coating. However, the presence of a higher pore density on the surface of the MAO coatings increases the effective surface area and thus the tendency of a corrosive medium to adsorb and concentrate into these pores. Thus, the pore density, distribution of pores and interconnectivity of the pores with the remainder of the substrate can be important factors. In various aspects of the present disclosure, the oxide layer 64 or ceramic layer of a corrosion resistant coating may be generated or formed having a controlled and substantially uniform porosity of greater than or equal to about 0.1 μm to less than or equal to about 5 μm, optionally greater than or equal to about 1 μm to less than or equal to about 3 μm, or optionally greater than or equal to about 0.1 μm to less than or equal to about 1 μm. In certain variations, the generating of the oxide layer comprises maintaining an average pore size in the oxide layer within a range of greater than or equal to about 1 μm to less than or equal to about 3 μm. The oxide layer 64 may be generated or formed having a substantially uniform thickness of greater than or equal to about 2 μm to less than or equal to about 30 μm, optionally greater than or equal to about 4 μm to less than or equal to about 25 μm, or greater than or equal to about 5 μm to less than or equal to about 20 μm.

To address the disadvantages associated with coatings formed by MAO processes (having the presence of the porous oxide or ceramic layer), a sealing coating system can be applied. As such, in certain aspects, such a sealing coating system includes a first coating 66, or electrostatic layer, may be applied onto the oxide layer 64 using an electrocoating technique (“e-coating” or electrophoresis coating) that is configured to seal the oxide layer and provide for increased adhesion of optional additional layers applied thereon. Thus, the corrosion resistant coating 63 may also include a first coating 66 applied onto the oxide layer 64 using an electro-coating technique and may be configured to seal the oxide layer 64. A second coating 68 may then be applied onto the first coating 66. The second coating 68 may be disposed over the first coating 66. The second coating 68 may be applied via an electrostatic process and include a powdered coating material.

Prior to the electrocoating, the workpiece may optionally be washed or immersed in deionized water. Typical sealer systems that may be used in conjunction with the MAO processes may include a wide variety of polymers and resins, including but not limited to, fluoropolymers, acrylic, epoxy, polyester, polysiloxanes, and polyvinylidene fluoride (PVDF). These materials may be applied in the form of electrostatically sprayed coatings, by electrophoretic deposition, or by known dipping or wet spraying techniques. In one variation that can be used with magnesium workpieces such as magnesium or magnesium alloy wheels, an epoxy resin may be used, for example, EPDXY RESIN KATAPHORESIS COATING (EED-060M), commercially available from Unires, or its constituent company Tianjin Youli Chemical Co., Ltd. of Tianjin, China. Generally, the first coating will not contain a significant amount of any chemically active agent therein. The e-coating treatment process may take place from 0 to about 3 minutes using a voltage of between about 160V to about 220V, and cured at a temperature of greater than or equal to about 160° C. to less than or equal to about 180° C. for a curing time of greater than or equal to about 20 to less than or equal to about 30 minutes.

A finish or appearance coating 70 may optionally be applied over at least a portion the second coating 68 (for example, the outboard side 34). As is known in the art, the appearance coating 70 may include one or more coatings that impart a desired color, shine, and/or gloss to the workpiece. By way of example, the appearance coating 70 may include one or more of a base coat 72, a color coat 74, a clear coat 76, and any combinations thereof. While FIG. 4 shows a distance or spatial gap between the base coat 72 of the appearance coating 70 and the second coating 68, the appearance coating 70 is directly applied onto the second coating 68 and the gap is only provided to illustrate the optical nature of the appearance coating 70.

In certain aspects, the approaches adopted with the present teachings include applying the first coating 66 on the oxide layer within less than about 30 hours, and preferably less than about 24 hours, less than about 20 hours, or less than about 16 hours after generating or forming the oxide or ceramic oxide layer. In addition to the timing considerations, the substrate or workpiece can be maintained in an ambient temperature environment having humidity conditions of less than about 70%, less than about 65%, and preferably less than about 60% relative humidity after generating the oxide layer 66 and prior to applying the first coating. It is envisioned that the timing and environmental conditions disclosed herein may provide increased corrosion resistance between the e-coating layer (first layer 66) and the oxide or ceramic layer (oxide layer 64). In various aspects, the first coating 66 is applied having a substantially uniform thickness of greater than or equal to about 10 μm to less than or equal to about 50 μm, or greater than or equal to about 15 μm to less than or equal to about 40 μm, or greater than or equal to about 15 μm to less than or equal to about 35 μm, or about 30 μm.

As known in the art, a wide range of materials and methods for encapsulation are commercially available that provide for a variety of strategies to create the degree of durability and corrosion resistance. The approaches adopted in accordance with certain aspects of the present teachings include applying a second coating 68 onto the first coating 66. Second coating 68 may include a powder coating material that is electrophoretically applied. Powder coating materials useful herein may include thermoplastic or reactive polymers commonly used in the art that are typically solid at room temperature. Most powders are reactive one-component systems that liquefy, flow, and then crosslink as a result of treatment with heat. Common polymers that may be used as powder coating materials include polyester, polyurethane, polyester-epoxy (known as hybrid), straight epoxy (fusion bonded epoxy), and acrylics.

In various aspects, the methods of the present teachings include heating the workpiece or substrate having the first coating 66 to a temperature of greater than or equal to about 80° C. to less than or equal to about 100° C. prior to applying the second coating, or powder coating material layer. By way of example, in one aspect, the method of applying the powder coating second coating 68 onto the first coating 66 can include electrostatically spraying a wet black resin powder onto the oxide layer of a heated substrate, the resin powder being delivered at a voltage of greater than or equal to about 40 kV to less than or equal to about 50 kV, or about 45 kV, and a current of greater than or equal to about 0.4 A to less than or equal to about 0.6 A, or about 0.5 A. In one presently preferred aspect that can be used with magnesium workpieces having an epoxy resin first coating, the second coating may include a powder coating mainly containing a large portion of polyurethane. It may include, for example, a TIGER DRYLAC® powder coating “wet black” 049/80036, having a high gloss, commercially available from TIGER Coatings GmbH & Co, of Austria.

The methods of the present teachings may further include curing and condensing the powder coating second coating 68 by placing the workpiece or substrate in a heated environment at a temperature of greater than or equal to about 180° C. to less than or equal to about 200° C., or about 190° C., for a time period of greater than or equal to about 15 minutes to less than or equal to about 25 minutes, or about 20 minutes.

In various aspects, the second coating 68 is applied having a substantially uniform thickness of greater than or equal to about 25 μm to less than or equal to about 150 μm, or greater than or equal to about 50 μm to less than or equal to about 150 μm, or greater than or equal to about 70 μm to less than or equal to about 130 μm, or greater than or equal to about 80 μm to less than or equal to about 120 μm, or about 100 μm. In certain aspects, the first coating 66 can be applied onto the oxide layer having a first thickness, and the second coating can be applied onto the first layer having a second thickness. It may be beneficial to have a powder material coating having a thickness much greater than the electrocoating in order to provide increased corrosion protection. Thus, the approaches adopted with the present teachings may include applying the second layer having a second thickness of greater than or equal to about 1.5 to less than or equal to about 10 times greater than the first thickness of the first coating. Accordingly, by way of example, in certain aspects a first coating having a thickness of about 15 μm may be used with a second coating having a thickness of greater than or equal to about 25 μm to less than or equal to about 150 μm.

It should be understood that the present technology is not dependent on, nor limited to, any particular type of material or production method, and the materials and methods may be varied as desired, based on the intended results. The light metal and alloys provided with the enhanced surface protection coatings disclosed herein have been shown to have superior adhesion qualities, resistance to chipping, resistance to thermal shock, and minimal scratch corrosion.

The coatings and treatments discussed above and herein in the context of FIG. 4 for corrosion protection provide excellent corrosion resistance, good adhesion with the underlying alloy matrix, and uniform in-side coating growth. Thus, certain coatings and treatments discussed above in may be applied to the entire workpiece, or select portions thereof. For example, both the inboard side 32 and the outboard side 34 of a wheel may be subjected to methods of the present teachings that apply enhanced corrosion protection coatings, but it may be desirable to only apply an appearance layer (discussed in more detail below) to the visible outboard side 34. However, in accordance with certain aspects of the present disclosure, different surface regions of the exposed surface of the light metal workpiece may be identified based on relative corrosion susceptibility (e.g., regions of the workpiece that will have increased exposure to one or more corrosive agents in an external environment when used in service conditions). The full immersion that occurs during the MAO process can make it challenging to selectively coat or provide different thicknesses on different surface regions, thus providing less control and ability to tailor the coating. Further, the coatings and treatments discussed above and herein in the context of FIG. 4 for corrosion protection tend to consume large amounts of electricity during processing and thus tend to be relatively expensive.

Thus, in accordance with certain aspects of the present disclosure, only select surface regions of the exposed surface of a light metal workpiece, those regions having the highest susceptibility to corrosion may have the coatings and treatments discussed above and herein in the context of FIG. 4. Other regions having relatively low susceptibility to corrosion (outside the select regions) may have different types of corrosion protection or different levels of corrosion protection coatings. Thus, the present disclosure provides a tailor coating process that can apply different thickness of corrosion resistant ceramic coating on different locations of the exposed surface of a light metal workpiece, to cost effectively address the corrosion protection of a work piece based on its application requirements, though special design of the coating process and/or tooling.

In certain aspects, the present disclosure contemplates a light metal workpiece with tailored corrosion resistant surface protection. The light metal workpiece has a metal or alloy matrix having an exposed surface defining a first region and a second distinct region. With reference to FIG. 5, a light metal workpiece in the form of a wheel 80 is shown. The wheel 80 has an exposed surface 82 that includes a first region 84 and a distinct second region 86. The first region 84 will experience increased exposure to one or more corrosive agents in an external environment, as compared to the second region 86. For example, the first region 84 may encompass those exposed surface regions that have high levels of corrosion susceptibility, such as first surface regions 50 and optionally select portions of the second surface regions 52 on wheel 10 in FIG. 3. The second region 86 has a lower amount of susceptibility to corrosion and exposure to one or more corrosive agents in the external environment as compared to the first region 84. For example, second region 86 may include the third surface regions 54 of the wheel 10 in FIG. 3. Thus, the first region 84 of wheel 80 may require a high level of corrosion protection, while the second region 86 may only require mild corrosion protection.

A corrosion resistant coating is formed over the first region of the exposed surface that comprises a corrosion resistant oxide layer formed by a micro-arc oxidation (MAO) process. The corrosion resistant coating may also include at least one sealant coating applied onto at least a portion of the corrosion resistant oxide layer using an electro-coating technique and configured to seal the oxide layer. In certain aspects, the sealant coating may include a first coating applied onto at least a portion of the corrosion resistant oxide layer using an electro-coating technique. The first coating is configured to seal the oxide layer. A second coating may also be applied onto at least a portion of the first coating, where the second coating comprises a powder coating material.

In certain preferred aspects, the corrosion resistant oxide layer formed by MAO is applied to the first region has a thickness of greater than or equal to about 5 μm. The corrosion resistant oxide layer may have a thickness of from greater than or equal to about 5 μm to less than or equal to about 20 μm. In certain variations, the generating of the oxide layer comprises maintaining an average pore size in the oxide layer within a range of greater than or equal to about 1 μm to less than or equal to about 3 μm. The first coating of the sealant coating may have a thickness of greater than or equal to about 15 inn to less than or equal to about 35 μm, while the second coating of the sealant coating may have a thickness of greater than or equal to about 50 μm to less than or equal to about 150 μm.

In certain variations, the corrosion resistant coating is a first corrosion resistant coating and the second regions have a second corrosion resistant coating distinct from the first corrosion resistant coating formed thereon. In certain variations, the first corrosion resistant coating may be the same composition as the second corrosion resistant coating, but they may have different thicknesses. For example, the corrosion resistant oxide layer of the first corrosion resistant coating may have a thickness of greater than or equal to about 5 μm, while the second corrosion resistant coating also comprises a corrosion resistant oxide layer formed by micro-arc oxidation. However, the second corrosion resistant coating may have a thickness of less than or equal to about 5 μm. The additional corrosion resistant coating layers and/or appearance coating 70 may be selectively employed with the first corrosion resistant layer and the second corrosion resistant layer and may be the same as those described previously above.

The methods and products prepared in accordance with certain aspects of the present disclosure enable cost reduction by reducing coating thickness and/or surface area covered by the expensive corrosion resistant oxide layer formed by MAO. Another advantage is increased throughput during processing of more workpieces under the same power supplier. Further, the methods and products prepared in accordance with certain aspects of the present disclosure effectively improve the corrosion resistance in localized areas to mitigate corrosion.

In certain aspects, methods of providing an enhanced surface coating on a metal or alloy substrate include providing a metal or alloy substrate having an exposed surface defining a first region and a second distinct region. The first region has increased exposure to one or more corrosive agents in an external environment as compared to the second region. An oxide layer may be formed on the first region of the exposed surface of the substrate using a micro-arc oxidation process. Then, at least one sealant coating is applied onto at least a portion of the corrosion resistant oxide layer on the first region using an electro-coating technique and configured to seal the oxide layer. In certain variations, the applying of the at least one sealant coating may include applying a first coating layer onto the oxide layer using an electro-coating technique and then applying a second coating layer onto the first coating layer, the second coating layer comprising a powder material coating. In certain aspects, the first region and the second region have a distinct coating. By distinct coating, it is meant that the coatings may have a distinct chemical composition (or where there are multiple layers or multiple coatings, at least one coating is different) or that at least one layer or coating has a different thickness in the first region as compared to the second region.

In certain variations, the second region may have no oxide or ceramic layer, but may include the at least one sealant coating and an optional appearance coating, as described previously above. In other variations, the second region may also have a corrosion resistant oxide layer like the first region; however, the corrosion resistant oxide layer is significantly thicker in the first region than the second region. For example, the corrosion resistant oxide layer may be 2 to 20 times thicker in the first region than in the In other aspects, the second region may have a distinct corrosion coating disposed thereon, such as a chemical conversion coating that will be described in greater detail below.

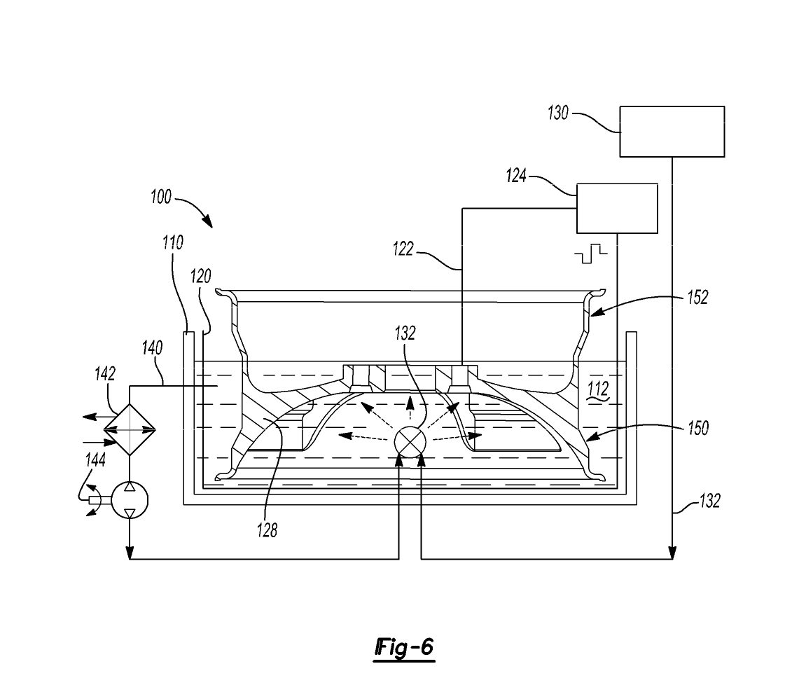

One variation of a method of selectively applying corrosion resistant coatings to a first region and a second distinct region of the workpiece can be demonstrated in the context of FIG. 6. An exemplary micro-arc oxidation processing system 100 is shown in FIG. 6. A container 110 contains an electrolyte 112 defining an electrolyte bath. The system 100 includes a first electrode or cathode 120, a second electrode or anode 122, and a power source 124 in electrical communication with one another. The anode is contacted with a light metal workpiece 128. When potential is applied via the power source 124 to the cathode 120 and anode 122, an electrolytic reaction occurs within the electrolyte on the exposed surfaces of the light metal workpiece to form an oxide layer via micro-arc oxidation by plasma discharge. A thickness of the oxide layer coating formed on the exposed surfaces is a function of the amount of power/potential applied and time that the workpiece is processed, among other parameters. The system 100 also includes an electrolyte processing system that includes a compressed air system 130 that delivers compressed air for agitation into the electrolyte bath via an inlet 132 disposed in the electrolyte 112 in the container 110. The electrolyte processing system also includes an electrolyte recirculation system 140. The electrolyte recirculation system 140 may include a heat exchanger 142 and a pump 144 that circulates and processes (e.g., heats or cools) electrolyte 112. While not shown, the electrolyte recirculation system 140 may include a source of fresh electrolyte and an electrolyte removal system to bleed off and remove spent electrolyte 112.

In a conventional micro-arc oxidation processing system, the container or housing is sized to have dimensions such that the workpiece is fully immersed and covered or otherwise in contact with electrolyte 112 during processing. However, in the micro-arc oxidation processing system 100 in FIG. 6, the container 110 has dimensions customized to the light metal workpiece 138, so that only a portion of the light metal workpiece 138 is immersed or submerged in electrolyte 112. Thus, only a lower portion 150 of the light metal workpiece 138 contacts the electrolyte 112 and has an oxide layer formed by micro-arc oxidation thereon. An upper portion 152 of the light metal workpiece 138 does not contact the electrolyte 112 and thus has no oxide layer MAO coating formed thereon. In this manner, the MAO ceramic coating can be selectively applied to a preselected first region of the light metal workpiece 138 having the highest levels of corrosion susceptibility. The light metal workpiece 138 may then have a corrosion coating(s) applied to the upper portion 152. The corrosion coating(s) applied to the upper portion 152 may be the same as those applied to the lower portion 150 or may be distinct from those applied to the lower portion 150. In certain aspects, the upper portion 152 and lower portion 150 may share some of the plurality of distinct coating layers applied. In certain variations, the oxide layer coating may be applied to the lower portion 150 of the light metal workpiece 138 in the micro-arc oxidation processing system 100 for a longer processing time or at greater power levels to create a thicker coating to provide enhanced corrosion protection. Then, the light metal workpiece 138 may be rotated 180° in orientation and placed in contact with electrolyte (in the same bath or a different MAO processing station bath) and an MAO ceramic coating can be applied to the exposed surface of the upper portion 152 (now submerged) for less processing time and/or at less potential to create a thinner oxide layer coating providing adequate protection against milder corrosion conditions. In other variations, discussed further herein, the upper portion 152 may have an entirely distinct corrosion protection coating (e.g., a distinct composition) applied. In this manner, a highly customized corrosion protection coating system is provided on a light metal workpiece that enhances corrosion protection will reducing overall cost.

After processing and forming the oxide layer in the first region (and optionally in the second region) of the light metal workpiece, the methods may include applying at least one sealant coating. Such applying of a sealant coating may include applying a first coating onto at least a portion of the corrosion resistant oxide layer using an electro-coating technique. The first coating is configured to seal the oxide layer, as described previously above. The methods may further include heating the metal workpiece to a temperature of greater than or equal to about 80° C. to less than or equal to about 100° C. prior to applying a second coating layer. The applying of the second coating layer onto the first coating layer may include electrostatically spraying a wet black resin powder onto the oxide layer, delivered at a voltage of greater than or equal to about 40 kV to less than or equal to about 50 kV and a current of greater than or equal to about 0.4 A to less than or equal to about 0.6 A.

The methods may further include curing and condensing the powder material coating by placing the substrate in a heated environment at a temperature of greater than or equal to about 180° C. to less than or equal to about 200° C. for a time period of greater than or equal to about 15 minutes to less than or equal to about 25 minutes. In certain aspects, the methods may include applying the first coating layer on the oxide layer within less than about 24 hours after generating the oxide layer, and maintaining the substrate in an environment having humidity conditions of less than about 60% relative humidity after generating the oxide layer and prior to applying the first coating layer. In other aspects, the methods may further comprise applying an appearance coating over the at least one sealant coating, for example, over the powder coating layer. The appearance coating optionally comprises at least one of a base coat, a color coat, and a clear coat, as described above.

In certain aspects, the oxide layer is generated on the first region of the light metal workpiece having a thickness of greater than or equal to about 5 μm to less than or equal to about 20 μm, optionally at greater than or equal to about 5 μm to less than or equal to about 15 μm. The first coating layer may have a thickness of greater than or equal to about 15 μm to less than or equal to about 35 μm, and the second coating layer is provided having a thickness of greater than or equal to about 50 μm to less than or equal to about 150 μm. In certain variations, the light metal workpiece comprises magnesium, so that the MAO oxide layer in the first region comprises a magnesium oxide ceramic. The at least one sealant coating includes a first coating layer comprising an epoxy resin and a second coating layer comprising polyurethane.

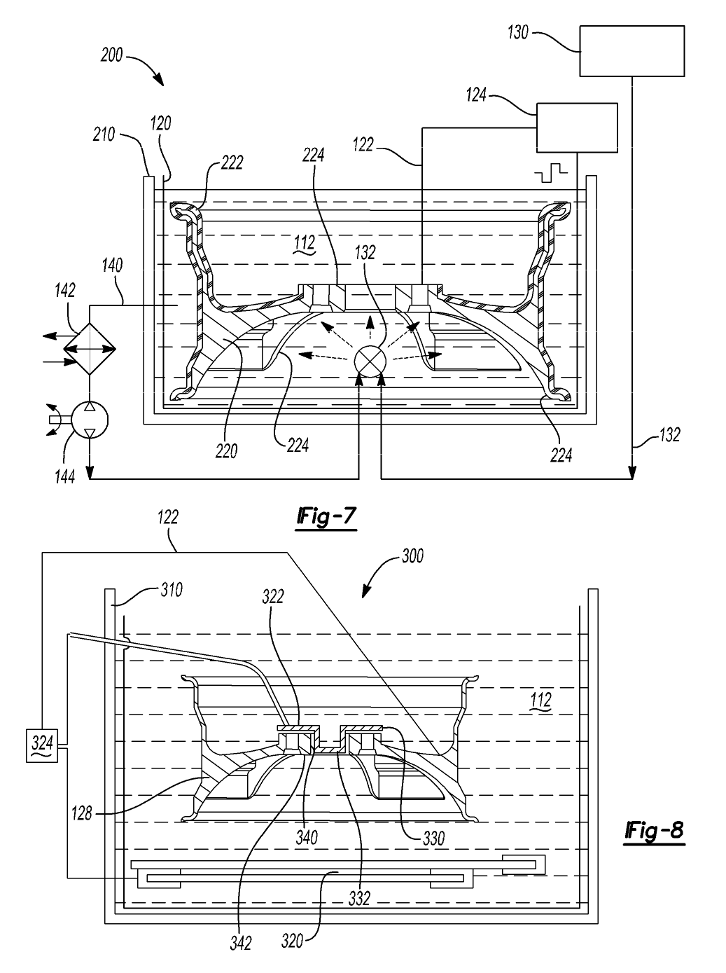

Another variation of a method of selectively applying corrosion resistant coatings to a first region and a second distinct region of the workpiece is shown in FIG. 7, which is similar to the micro-arc oxidation processing system 100 shown in FIG. 6. To the extent that the components are the same, they share the same reference numbers and unless otherwise discussed herein, are not described again for brevity. In FIG. 7, an exemplary micro-arc oxidation processing system 200 is shown that includes a container 210 holding electrolyte 112 defining an electrolyte bath. The container 210 is dimensioned so that a light metal workpiece 220 is fully in contact with electrolyte 112 (submerged or immersed in electrolyte 112). A mask 222 can be applied on preselected regions of an exposed surface of the light metal workpiece 220. The mask 222 insulates and protects the workpiece 220 from formation of any oxide coating(s). Unmasked regions 224 of the exposed surface of light metal workpiece 220 thus are in contact with electrolyte 112. The preselected regions where the mask 222 is applied can be identified based on having relatively low levels of corrosion susceptibility, for example, corresponding to the third surface regions 54 and optionally some or all of the second surface regions 52 in FIG. 3.

When potential is applied via a power source 124 to a cathode 120 and anode 122, an oxide layer is formed via micro-arc oxidation on unmasked regions 224 of the light metal workpiece 220 in contact with electrolyte 112 by plasma discharge and reaction. As discussed above, a thickness of the oxide layer coating formed on the exposed surfaces is a function of the amount of power/potential applied and time that the workpiece is processed, by way of example. In this manner, a corrosion protection oxide layer is formed on a first region of the exposed surface of the substrate of the workpiece using a micro-arc oxidation process. After the formation of the corrosion protection oxide layer, the mask 222 can be removed, thus defining a second region. The second region of the exposed surface of the workpiece can then be treated to have a distinct coating. The second region may be treated to have a distinct coating as described above or further herein. In this manner, a highly customized corrosion protection coating system is provided on a light metal workpiece that enhances corrosion protection will reducing overall cost.

In certain variations, where the second region of the workpiece has been masked, after removal of the mask a conversion coating for corrosion protection may be applied to the second region. Such a corrosion protection conversion coating may be formed on the second region of the surface of the workpiece via an anodizing reaction that may occur, for example, in an electrolytic bath having an electrolyte with compounds that facilitate formation of the conversion coating. Conversion coatings that passivate light metal alloys, such as those containing aluminum and magnesium, can be formed by use of electrolytic reaction using treatment agents, such as chromates, phosphates, stannate, ferric nitrate, cerium oxide, galvanic black anodizing coating, and others well known in the art.

Certain non-limiting examples of suitable preferred conversion coatings are formed by the following treatments. Magnesium chromic treatments (SAE-AMS-M-3171 or MTh-M-3171), such as those found in M. Avedesian, ASM Specialty Handbook, Magnesium and Magnesium Alloys, ASM International Handbook Committee (1999), pp. 142-144, incorporated herein by reference, may include a chromate-pickle treatment, such as Type I or Dow 1 that includes a chromic acid pickle and/or sulfuric acid pickle, followed by treatment with a solution of sodium dichromate, nitric acid, and optionally potassium or ammonium acid fluoride, or a dichromate treatment, such as a Type III or Dow 7 that includes treatment with a solution comprising sodium dichromate optionally including calcium or magnesium fluoride. Other suitable treatment agents include solutions of phosphates, such as a solution comprising Zn₃(PO₄)₂, Zn(NO₃)₂, and/or Zn(BF₄)₂. A conversion coating can be formed by exposing the metal substrate to such a solution at a temperature of 75° C. to 85° C. for a processing time of about 5 minutes, by way of example. Another suitable treatment agent for forming a conversion coating includes a solution of stannates, for example a solution comprising NaOH, K₂SnO₃.3H₂O, NaC₂H₃O₂.3H₂O, and/or Na₄P₂O₇. A conversion coating can be formed by exposing the metal substrate to such a solution at a temperature of about 82° C. for a processing time of about 10 minutes, by way of example. Suitable thicknesses for a conversion coating may be greater than or equal to about 2 μm to less than or equal to about 15 μm.

While conversion coatings may not have sufficient corrosion protection capabilities for the first regions of the exposed surface of a light metal or alloy matrix that have the greatest exposure to corrosive agents and susceptibility to corrosion, such conversion coatings may be quite sufficient for the second distinct surface regions having lower risk of exposure to corrosive agents depending on the end use and service conditions. In this manner, a hybrid corrosion resistance system highly tailored to the workpiece is provided, including a conversion or other type of corrosion protection coating (having relatively lower corrosion protection properties) on the second surface regions and a high level of corrosion protection via the corrosion protection oxide coating layer and the at least one sealant layer on the first surface regions.

In yet another variation, a method of selectively applying corrosion resistant coatings to a first region and a second distinct region of the workpiece is shown in FIG. 8, which is similar to the micro-arc oxidation processing system 100 or 200 shown in FIGS. 6 and 7. Again, to the extent that the components are the same, they share the same reference numbers and a discussion will not be repeated unless otherwise discussed herein. In certain aspects, the methods of the present disclosure contemplate selectively controlling an electric field within the micro-arc oxidation process when forming the corrosion protection oxide layer, so that a thickness of the oxide layer is controlled in select regions. By controlling the electric field within the electrolyte bath, an oxide layer can be applied at greater thicknesses in regions corresponding to the first region(s) of the lightweight metal workpiece and with diminished thicknesses in regions corresponding to the second region(s) of the lightweight metal workpiece. Once such method of controlling the electric field in accordance with the present disclosure is shown in FIG. 8.

In FIG. 8, an exemplary micro-arc oxidation processing system 300 is shown that includes a container 310 holding electrolyte 112 defining an electrolyte bath. Notably, certain features shown in FIGS. 6 and 7 are not reproduced in FIG. 8, but may be used with such a micro-arc oxidation processing system 300. The container 310 is dimensioned so that a light metal workpiece 128 is fully in contact with electrolyte 112 (submerged or immersed in electrolyte 112).

The micro-arc oxidation processing system 300 includes a first cathode 320 and a second customized cathode 322, a second electrode or anode 122, and a power source 324 in electrical communication with one another. The anode 122 is contacted with a light metal workpiece 128. When potential is applied via the power source 324 to the first cathode 320, second customized cathode 322 and anode 122, an oxide layer is formed via micro-arc oxidation on exposed surfaces of the light metal workpiece by plasma discharge. The second customized cathode 322 has a contoured shape that can be placed in near proximity to the light metal workpiece 128. The second customized cathode 322 may have a diameter or dimension smaller than the outer portion of the workpiece (e.g., a smaller diameter than the diameter defined by rim 16 of the outer wheel portion 14 of wheel 10 in FIGS. 1-2) to facilitate localized and concentrated electric fields near preselected regions of the workpiece. In this manner, the concentrated electric fields can increase the localized thickness of an oxide layer coating formed on the exposed surfaces of the workpiece.

In certain aspects, the second customized cathode 322 has a shape that contours to the shape of the workpiece, so that it may be placed in near proximity to the workpiece without coming in contact with it. In certain aspects, the second customized cathode 322 has a diameter smaller than the outer portion or rim of the wheel (e.g., a smaller diameter than the diameter defined by rim 16 of the outer wheel portion 14 of wheel 10 in FIGS. 1-2). The second customized cathode 322 is shown as having a shape defining a contoured outer disc 330 with a protruding central hub 332. The central hub 332 can be disposed within a recessed area 340 of a center portion 342 of the wheel workpiece 128. In this manner, the localized electric fields in the electrolyte bath are concentrated near the center portion 342 by the second customized cathode 322. As such, a thickness of the oxide layer formed on the workpiece 128 is greatest around and within the central portion 342. The remainder of the workpiece 128 also has an oxide layer formed thereon to define the second region requiring less corrosion protection, but the oxide layer is relatively thin as compared to the thickness of the coating in and near the central portion 342. Thus, this method provides the ability to coat the entire workpiece with a corrosion resistant oxide coating, but further provides the ability to apply a thicker oxide coating in the preselected first region of the workpiece requiring high corrosion protection by controlling the electric fields in the electrolyte, while fully coating the entire workpiece. Notably, other shapes, sizes, and number of customized cathode components can be used with such a technique, providing the ability to tailor the precise location and thickness of the oxide layer coating to workpieces having different sizes and shapes.

The present disclosure contemplates tailor coating or customizing a light metal workpiece having a metal or alloy matrix to effectively enhance the corrosion performance. While the above-described methods indicate that the exposed surface includes at least a first region and a second distinct region, a plurality of distinct surface regions may be identified on the workpiece surface having different corrosion protection requirements. Thus, the techniques above, including the masking techniques and sequential processing steps can be used to create three or more distinct corrosion protection coatings customized to a light metal alloy workpiece. For example, in the context of FIG. 3, a lightweight metal wheel 10 comprising a valve metal or alloy classifies three distinct regions with different levels of corrosion susceptibility. The first surface regions 50 have the greatest susceptibility to corrosion by wild exposure or galvanic contact with other components. Second surface regions 52 are also susceptible to corrosion, but can be considered to require a medium or middle level of corrosion protection. Lastly, third surface regions 54 require only a low level of corrosion protection. In certain variations, each of the distinct surface regions with distinct levels of corrosion susceptibility may have distinct coatings or corrosion treatment. However, in some variations, the second surface regions 52 (or portions of the second surface regions 52) may be considered to be part of the first region requiring the greatest corrosion protection and thus having the first corrosion resistant coating, while in other variations the second surface regions 52 (or portions of the second surface regions 52) may be considered to be part of the second distinct region having diminished requirements for corrosion protection.

Several exemplary embodiments of customized corrosion protection coatings for a matrix or alloy wheel are described in Table 1 below (corresponding to the select surface regions shown in FIG. 3).

TABLE 1

| | Coating for | Coating for | Coating for |
|---|---|---|---|
| | Greatest Corrosion | Mid Corrosion | Lowest Corrosion |
| | Protection | Protection | Protection |
| | Requirement- | Requirement- | Requirement- |
| | First Surface | Second Surface | Second Surface |
| Embodiment | Region(s) 50 | Region(s) 52 | Region(s) 54 |
| 1 | (i) Ceramic oxide layer | (i) No ceramic oxide | No coating |
| | with thickness of 5 | layer | |
| | μm-15 μm | (ii) Optional at least one | |
| | (ii) At least one sealant | sealant coating | |
| | coating | (iii) Optional at least one | |
| | (ii) At least one | appearance coating | |
| | appearance coating | | |
| 2 | (i) Ceramic oxide layer | (i) Ceramic oxide layer | No coating |
| | with thickness of 5 μm- | with thickness of 0.1 μm- | |
| | 15 μm | 5 μm | |
| | (ii) At least one sealant | (ii) At least one sealant | |
| | coating | coating | |
| | (ii) At least one | (ii) At least one | |
| | appearance coating | appearance coating | |
| 3 | (i) Ceramic oxide layer | (i) Other corrosion | No coating |
| | with thickness of 5 μm- | coating layer (e.g., | |
| | 15 μm | chemical conversion | |
| | (ii) At least one sealant | coating) | |
| | coating | (ii) Optional at least one | |
| | (ii) At least one | sealant coating | |
| | appearance coating | (iii) Optional at least one | |
| | | appearance coating | |
| 4 | (i) Ceramic oxide layer | (i) No ceramic oxide | (i) No ceramic oxide |
| | with thickness of 5 μm- | layer | layer |
| | 15 μm | (ii) Optional at least one | (ii) Optional at least one |
| | (ii) At least one sealant | sealant coating | sealant coating |
| | coating | (iii) Optional at least one | (iii) Optional at least one |
| | (ii) At least one | appearance coating | appearance coating |
| | appearance coating | | |
| 5 | (i) Ceramic oxide layer | (i) Ceramic oxide layer | (i) No ceramic oxide |
| | with thickness of 5 μm- | with thickness of 0.1 μm- | layer |
| | 15 μm | 5 μm | (ii) Optional at least one |
| | (ii) At least one sealant | (ii) At least one sealant | sealant coating |
| | coating | coating | (iii) Optional at least one |
| | (ii) At least one | (ii) At least one | appearance coating |
| | appearance coating | appearance coating | |
| 6 | (i) Ceramic oxide layer | (i) Other corrosion | (i) No ceramic oxide |
| | with thickness of 5 μm- | coating layer (e.g., | layer or conversion |
| | 15 μm | chemical conversion | coating |
| | (ii) At least one sealant | coating) | (ii) Optional at least one |
| | coating | (ii) Optional at least one | sealant coating |
| | (ii) At least one | sealant coating | (iii) Optional at least one |
| | appearance coating | (iii) Optional at least one | appearance coating |
| | | appearance coating | |
| 7 | (i) Ceramic oxide layer | (i) Other corrosion | (i) Other corrosion |
| | with thickness of 5 μm- | coating layer (e.g., | coating layer (e.g., |
| | 15 μm | chemical conversion | chemical conversion |
| | (ii) At least one sealant | coating) | coating) |
| | coating | (ii) Optional at least one | (ii) Optional at least one |
| | (ii) At least one | sealant coating | sealant coating |
| | appearance coating | (iii) Optional at least one | (iii) Optional at least one |
| | | appearance coating | appearance coating |

Such customized corrosion protection coatings for a matrix or alloy workpiece can be achieved by partially coating the high protection region(s) through control of the electrolyte contact region on the workpiece to effectively achieve good corrosion resistant. In other variations, the coating thickness can be tailored, for example, by applying thicker coatings in the high protection region(s) through control the electric field in the electrolyte to effectively achieve good corrosion resistance for the a matrix or alloy workpiece.

In this manner, the teachings of the present disclosure provide the ability to locally tailor corrosion resistant coatings in certain areas of lightweight metal alloy workpieces, thus providing improved corrosion resistance in localized and targeted areas, rather than uniformly coating the entire lightweight metal workpiece with a corrosion resistant coating. In certain aspects, a tailor coating process is provided that can apply a corrosion resistant ceramic coating on different locations of the workpiece surface at different thicknesses to improve corrosion protection and in other aspects, to cost effectively address the corrosion protection of a work piece based on its end-use application and requirements. Such processes provide enhanced, customized corrosion protection for corrosion prone lightweight metal alloy parts. Further, the present techniques can reduce manufacturing costs by reducing the surface area covered or thickness of a corrosion oxide coating to only the regions requiring such levels of corrosion protection. Further, throughput during MAO processing can be increased, as processing time can be reduced.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A light metal workpiece with tailored corrosion resistance surface protection, comprising:
a metal or alloy matrix having an exposed surface defining a first region and a second distinct region, wherein the first region has increased exposure to one or more corrosive agents in an external environment as compared to the second region and the metal or alloy matrix comprises at least one valve metal selected from the group consisting of aluminum, magnesium, titanium, and mixtures thereof;
a corrosion resistant coating selectively formed over the first region of the exposed surface comprising:
a corrosion resistant oxide layer formed by micro-arc oxidation; and
at least one sealant coating applied onto at least a portion of the corrosion resistant oxide layer using an electro-coating technique and configured to seal the corrosion resistant oxide layer.

2. The light metal workpiece of claim 1, wherein the at least one sealant coating comprises:
a first coating applied onto at least a portion of the corrosion resistant oxide layer using an electro-coating technique and configured to seal the oxide layer; and
a second coating comprising a powder coating material applied onto at least a portion of the first coating.

3. The light metal workpiece of claim 2, wherein the corrosion resistant oxide layer has a thickness of greater than or equal to about 5 μm to less than or equal to about 20 μm, the first coating has a thickness of greater than or equal to about 15 μm to less than or equal to about 35 μm, and the second coating has a thickness of greater than or equal to about 50 μm to less than or equal to about 150 μm.

4. The light metal workpiece of claim 1, wherein the corrosion resistant coating is a first corrosion resistant coating and a second corrosion resistant coating distinct from the first corrosion resistant coating is formed over the second region of the exposed surface.

5. The light metal workpiece of claim 4, wherein the corrosion resistant oxide layer of the first corrosion resistant coating is a first corrosion resistant oxide layer having a thickness of greater than or equal to about 5 μm and the second corrosion resistant coating also comprises a second corrosion resistant oxide layer formed by micro-arc oxidation having a thickness of less than or equal to about 5 μm.

6. The light metal workpiece of claim 5, wherein the first corrosion resistant oxide layer and the second corrosion resistant oxide layer respectively comprise a first coating applied thereon using an electro-coating technique configured to seal the oxide layer; and a second coating applied onto at least a portion of the first coating, the second coating comprising a powder coating material.

7. The light metal workpiece of claim 4, wherein the second corrosion resistant coating is a conversion coating.

8. The light metal workpiece of claim 1, wherein the valve metal comprises magnesium, the corrosion resistant oxide layer comprises a magnesium oxide ceramic, the first coating comprises an epoxy resin, and the second coating comprises polyurethane.

9. The light metal workpiece of claim 1, further comprising an appearance coating applied onto at least a portion of the at least one sealant coating, wherein the appearance coating comprises at least one of a base coat, a color coat, and a clear coat.

10. A method of creating a customized corrosion resistance coating system on an exposed surface of a light metal or alloy substrate, the method comprising:
generating a corrosion resistant oxide layer on a first region of the exposed surface of the light metal or alloy substrate using a micro-arc oxidation process, wherein the exposed surface further defines a second region having reduced potential for exposure to one or more corrosive agents in an external environment as compared to the first region and the light metal or alloy comprises at least one valve metal selected from the group consisting of aluminum, magnesium, titanium, and mixtures thereof; and
applying at least one sealant coating onto at least a portion of the corrosion resistant oxide layer using an electro-coating technique, wherein the at least one sealant coating is configured to seal the corrosion resistant oxide layer on the first region.

11. The method of claim 10, wherein the corrosion resistant oxide layer is a first corrosion resistant oxide layer and the method further comprises applying a second corrosion resistant coating distinct from the first corrosion resistant oxide layer on the second region of the exposed surface.

12. The method of claim 11, wherein the second corrosion resistant coating applied to the second region is a conversion coating.

13. The method of claim 12, wherein the conversion coating is formed by passivating the second region by electrolytic reaction with a treatment agent selected from the group consisting of: chromates, phosphates, stannates, ferric nitrates, cerium oxides, and combinations thereof.

14. The method of claim 10, further comprising applying a mask to the second region before the generating of the corrosion resistant oxide layer.

15. The method of claim 10, wherein the generating further comprises generating a second corrosion resistant oxide layer on the second region by micro-arc oxidation, so that the corrosion resistant oxide layer is a first corrosion resistant oxide layer, wherein the generating comprises immersing the first region and the second region in an electrolyte bath in electrical communication with an anode and a customized cathode that controls deposition of the first corrosion resistant oxide layer to a first thickness of greater than or equal to about 5 μm in the first region and controls deposition of the second corrosion resistant coating to a thickness of less than or equal to about 5 μm in the second region.

16. The method of claim 10, wherein the generating the corrosion resistant oxide layer on the first region comprises immersing the first region in an electrolyte bath comprising electrolyte, where the electrolyte only contacts the first region.

17. The method of claim 10, wherein the applying of the at least one sealant further comprises first applying a first coating layer onto the corrosion resistant oxide layer using an electro-coating technique and then applying a second coating layer comprising a powder material coating onto the first coating layer.

18. A method of creating a customized corrosion resistance coating system on an exposed surface of a magnesium or magnesium alloy matrix automotive component, the method comprising:
generating a corrosion resistant magnesium oxide layer on a first region of the exposed surface using a micro-arc oxidation process, wherein the exposed surface further defines a second region having reduced potential for exposure to one or more corrosive agents in an external environment as compared to the first region;
applying a first coating layer onto the corrosion resistant magnesium oxide layer using an electro-coating technique; and
applying a second coating layer onto the first coating layer, the second coating layer comprising a powder material coating comprising polyurethane.

19. The method of claim 18, wherein the method further comprises applying a second corrosion resistant coating distinct from the corrosion resistant magnesium oxide layer on the second region of the exposed surface.

20. The method of claim 18, further comprising applying an appearance coating over the second coating layer, wherein the appearance coating comprises at least one of a base coat, a color coat, and a clear coat.
